(19) United States
(12) Patent Application Publication
(10) Pub. No.: US 2010/0318428 A1
(43) Pub. Date: Dec. 16, 2010

(54) DYNAMIC PRIORITIZATION OF ADVERTISEMENTS AND CONTENT DELIVERY SYSTEM

(76) Inventor: James R. Birch, Spokane, WA (US)

Correspondence Address: KARL R CANNON, PO BOX 1909, SANDY, UT, 84091, US

(21) Appl. No.: 12/861,705

(22) Filed: Aug. 23, 2010

Related U.S. Application Data
(63) Continuation of application No. 12/756,949, filed on Apr. 8, 2010, now abandoned.
Application No. 12/756,949 is a continuation of application No. 12/544,962, filed on Aug. 20, 2009.
Application No. 12/544,962 is a continuation of application No. 12/326,014, filed on Dec. 1, 2008, now abandoned.
Application No. 12/326,014 is a continuation-in-part of application No. 12/177,077, filed on Jul. 21, 2008, now abandoned.
Application No. 12/177,077 is a continuation of application No. 12/074,553, filed on Mar. 3, 2008, now abandoned.
(60) Provisional application No. 60/928,315, filed on May 8, 2007.
(60) Provisional application No. 60/904,469, filed on Mar. 2, 2007.

(51) Int. Cl. G06Q 30/00

(52) U.S. Cl. 705/14.66; 705/14.4

(57) ABSTRACT

A system and method dynamically rendering advertisements to consumers based upon a service level of a service center. When the service level is unacceptable, the rendering of the advertisements to the consumers maybe curtailed until the service level rises to an acceptable level. The service level may be considered unacceptable when the wait time in a call queue exceeds a predetermined threshold. Prior to rendering, the advertisements may be stored in a computer-readable memory local to an electronic device associated with each of the consumers such that the advertisements may be rapidly accessed and rendered to the consumers upon receipt of an appropriate command signal. The receipt of a command signal to render an advertisement at the next available opportunity may be indicative that the service level of the service center is at an acceptable level.

### CROSS-REFERENCE TO RELATED APPLICATIONS

This application is a continuation of U.S. application Ser. No. 12/756,949, filed Apr. 8, 2010, which is a continuation of U.S. application Ser. No. 12/544,962, filed Aug. 20, 2009, which is a continuation of U.S. application Ser. No. 12/326,014, filed Dec. 1, 2008, which is a continuation-in-part of prior U.S. application Ser. No. 12/177,077, filed Jul. 21, 2008, which is a continuation of prior U.S. application Ser. No. 12/074,553, filed Mar. 3, 2008, which claims the benefit of U.S. Application Ser. Nos. 60/928,315, filed May 8, 2007, and 60/904,469, filed Mar. 2, 2007, which are hereby incorporated by reference herein in their entirety, including but not limited to those portions that specifically appear hereinafter, the incorporation by reference being made with the following exception: In the event that any portion of the above-referenced applications are inconsistent with this application, this application supercedes said above-referenced applications.

### STATEMENT REGARDING FEDERALLY SPONSORED RESEARCH OR DEVELOPMENT

Not Applicable.

### BACKGROUND

1. The Field of the Invention

The present disclosure relates generally to systems for rendering advertisements to consumers, and more particularly, but not necessarily entirely, to dynamically controlling the rendering of advertisements to consumers in order to maintain acceptable service levels at an inbound support center.

2. Description of Related Art

Advertisers often provide contact information in advertisements to allow members of the public, referred to herein as “consumers,” to immediately place an order for the advertised products or services. For example, advertisers may include a telephone number that allows consumers to place a phone-in order immediately after exposure to an advertisement. Not surprisingly, with the increased presence of consumers on the Internet, advertisers are employing alternatives to providing telephone numbers for placing orders. For example, many advertisers are utilizing on-line chat, email, and voice over IP to take advantage of online connections with consumers. Whether taking orders over the telephone or through an alternative online method, advertisers must typically provide, or contract with, a service center staffed by trained and knowledgeable customer service agents. These customer service agents are responsible for handling the inbound inquires from consumers related to the advertised products or services.

One difficulty associated with operating a service center is maintaining a proper support level such that consumers do not become frustrated with the ordering process. When consumers experience long hold times in queues while waiting to communicate with customer service agents, some consumers may abandon the attempt to place orders altogether. The loss of potential sales due to low service levels is clearly undesirable as it results in decreased profits. In order to lower consumer wait times, a service center may increase its infrastructure to provide an increased number of available customer service agents. However, this may also result in decreased profits if customer service agents are sitting idle due to overstaffing.

In the past, operators of service centers have engaged in complicated forecasting methods in an effort to properly balance staffing levels against demand and costs. However, these forecasting methods often fall short due to the inability of the advertisers to control the release of advertisements to consumers. In particular, due to the high cost of advertising, advertisers typically attempt to expose a relatively large number of consumers to an advertisement through the use of broadcast advertising. While this broadcast advertising may initially seem cost effective, this approach may cause associated service centers to experience low support levels for a period of time just after the advertisement is broadcast due to high demand.

The prior art is thus characterized by several disadvantages that are addressed by the present disclosure. The present disclosure minimizes, and in some aspects eliminates, the above-mentioned failures, and other problems, by utilizing the methods and structural features described herein. The features and advantages of the disclosure will be set forth in the description which follows, and in part will be apparent from the description, or may be learned by the practice of the disclosure without undue experimentation. The features and advantages of the disclosure may be realized and obtained by means of the instruments and combinations particularly pointed out in the appended claims.

### BRIEF DESCRIPTION OF THE DRAWINGS

The features and advantages of the disclosure will become apparent from a consideration of the subsequent detailed description presented in connection with the accompanying drawings in which:

FIG. 1 is a diagram illustrating an embodiment of a system pursuant to the present disclosure;

FIG. 2 is a diagram illustrating an embodiment of the electronic device illustrated in FIG. 1;

FIG. 3 is a diagram illustrating an embodiment of the centralized management system illustrated in FIG. 1;

FIG. 4 is a diagram illustrating an embodiment of a system pursuant to the present disclosure;

FIG. 5 is a flow chart according to an embodiment of the present disclosure;

FIG. 6 is a flow chart according to an embodiment of the present disclosure illustrating the placement of a targeted advertisement into a content stream;

FIG. 7 is a flow chart according to an embodiment of the present disclosure;

FIG. 8 is a flow chart according to an embodiment of the present disclosure;

FIG. 9 is a flow chart according to an embodiment of the present disclosure; and

FIG. 10 is a flow chart according to an embodiment of the present disclosure.

### DETAILED DESCRIPTION

It would be an advancement over the prior art to enable advertisers to dynamically regulate the number of consumers being exposed to an advertisement to thereby maintain acceptable service levels at an associated service center. It would be a further advancement over the prior art to enable advertisers to dynamically increase the number of consumers being exposed to an advertisement when service levels at a service center are high and dynamically decrease the number of consumers being exposed to an advertisement when customer service levels at the service center are low.

It would be a further advancement over the prior art to allow service levels, costs, quality of service, etc., to dictate when an advertisement and/or content will be delivered to a consumer, and in more particular, to a targeted consumer. It would be a further advancement over the prior art to allow the management of the delivery of advertisements across a variety of delivery platforms to thereby create a greater integration and synchronization with a corresponding higher value to the advertiser.

For the purposes of promoting an understanding of the principles in accordance with the disclosure, reference will now be made to the embodiments illustrated in the drawings and specific language will be used to describe the same. It will nevertheless be understood that no limitation of the scope of the disclosure is thereby intended. Any alterations and further modifications of the inventive features illustrated herein, and any additional applications of the principles of the disclosure as illustrated herein, which would normally occur to one skilled in the relevant art and having possession of this disclosure, are to be considered within the scope of the disclosure claimed.

It must be noted that, as used in this specification and the appended claims, the singular forms “a,” “an,” and “the” include plural referents unless the context clearly dictates otherwise. In describing and claiming the present disclosure, the following terminology will be used in accordance with the definitions set out below. As used herein, the terms “comprising,” “including,” “having,” “containing,” “characterized by,” and grammatical equivalents thereof are inclusive or open-ended terms that do not exclude additional, unrecited elements or method steps.

As used herein, the term “content stream” may mean information of an audio and/or visual nature that may be rendered through the use of an electronic device. The content stream may be embodied in a signal, including, without limitation, electromagnetic signals and light-based signals, either of a wired or wireless nature. The content stream may be embodied in a storage medium, including digital and analog storage mediums, such as hard drives, electronic memory, and optical storage mediums. The content stream may include information, including at least one of programming and advertisements. The content stream may be generated by a remote or local content source as described herein.

As used herein, the term “render,” and its grammatical equivalents, may mean to play, display, draw, interpret, decode, show, reproduce, or otherwise present the information in the content stream in a manner that can be perceived by a human. For example, the information in the content stream may be rendered to a user using a display, monitor, television, projector, or screen in combination with speakers.

Further, many of the functional units described in this disclosure have been labeled as “modules,” in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software code operating on a computer, sometimes referred to as computer readable instructions, for execution by various types of microprocessors. An identified module of executable code operating on a computer may, for instance, include one or more physical or logical blocks of computer instructions that may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code operating on a computer may be a single instruction operating on a single computer, or many instructions on a single computer or on multiple computers, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

Turning now to the present disclosure, applicant has discovered a system and method for dynamically regulating the rendering of advertisements to consumers in order to maintain acceptable service levels at customer service centers. In response to service levels falling below an acceptable threshold, the present disclosure may dynamically decrease the rate at which consumers are exposed to the advertisements. In response to service levels exceeding an acceptable threshold, the present disclosure may dynamically increase the rate at which consumers are exposed to the advertisements. In this manner, the present disclosure may be useful to optimize the effectiveness of the service center by regulating the number of consumers being exposed to an advertisement based upon service levels.

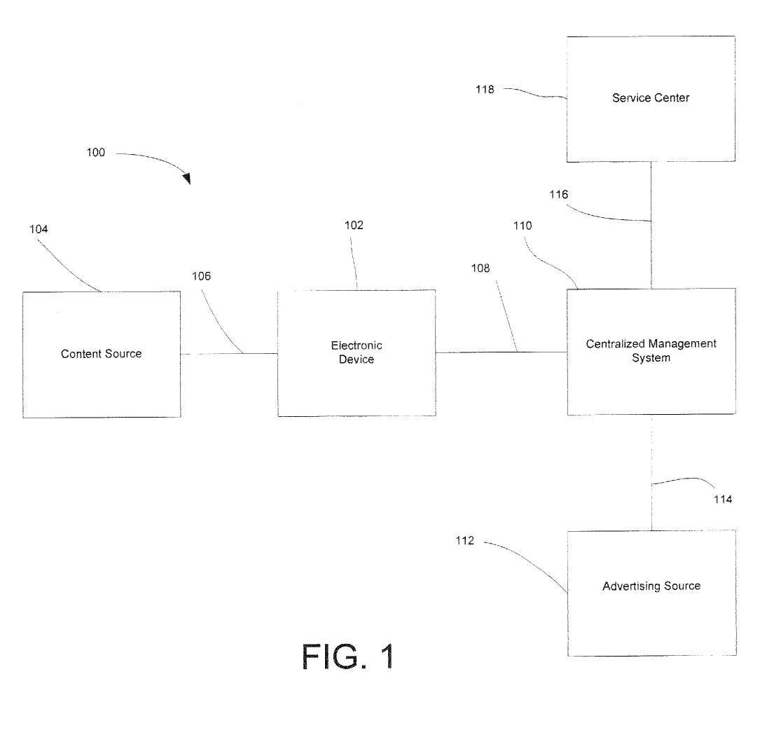

Referring now to FIG. 1, there is shown a diagram of an embodiment of a system 100 in accordance with the principles of an embodiment of the present disclosure. The system 100 may include an electronic device 102 and a centralized management system 110. The electronic device 102 may be operable to render a content stream to a user. In an embodiment of the present disclosure, the electronic device 102 may comprise a television. In an embodiment of the present disclosure, the electronic device 102 may comprise a cell phone. In an embodiment of the present disclosure, the electronic device 102 may comprise a computer, such as a handheld computer, a laptop computer, or a desktop computer. In an embodiment of the present disclosure, the electronic device 102 may comprise a portable or handheld electronic device, such as a digital music player (iPod®, mp3 player, etc.) and an internet access device. It will therefore be understood that the electronic device 102 may comprise any device that is able to render, either visually, audibly or otherwise, a content stream, to a user.

A content source 104 may provide a content stream to the electronic device 102 over a communication path 106. It will be appreciated that while only one content source 104 is depicted in FIG. 1, that any number of content sources may provide a content stream to the electronic device 102. For example, the electronic device 102 may have the ability to receive different channels, such as television channels or radio channels. In an embodiment of the present disclosure, the electronic device 102 may access different websites. The communication path 106 between the content source 104 and the electronic device 102 may comprise a wireless communication path, a wired communication path, or a combination of both. In an embodiment of the present disclosure, the content source 104 may be located remotely from the electronic device 102. In an embodiment of the present disclosure, the content source 104 may be located proximate the electronic device 102. In an embodiment of the present disclosure, the content source 104 may actually be integrated into the electronic device 102.

The content source 104 may include, without limitation, a television station network, a communications satellite, a cable TV station, a gaming system, a web server, a cellular phone network, electronic memory, a computer server, a music player, a computer, a DVD player, a Blu-Ray disc player, an HD DVD player, a high definition optical player, a CD player, a VCR player, a tape recorder, personal video recorder (“PVR”), an IPTV station, and any other similar and equivalent devices, now known or known in the future, that are able to transmit content streams for rendering to the electronic device 102. It should therefore be understood that the content source 104 includes any device, apparatus, system or network capable of providing a content stream to the electronic device 102.

The content stream may be delivered to the electronic device 102 from the content source 104 over the communication path 106. As mentioned, the communication path 106 may comprise a wired or wireless portion. If the communication path 106 includes a wireless communication path, the content stream may be transmitted using a radio frequency communication scheme such as those used for broadcast television, satellite TV, radio stations, pager networks, computer networks and cellular telephones. If the communication path 106 includes a wired communication path, the content stream may be transmitted using a communication scheme commonly used for cable TV networks, computer buses, fiber optic networks, power line communication networks, telephone lines, twisted pair, CAT-5, RCA cables, HDMI cables, coaxial cables, or any other type of conductor or light transmission device used to carry analog or digital information. In short, it should be recognized that, pursuant to the present disclosure, there is no limitation on the medium through which the content stream may be delivered to the electronic device 102 from the content source 104.

It will be noted that the content stream may originate from information stored in any type of storage medium, including analog and digital storage mediums. For example, if the content source 104 is a gaming system, the content stream may be generated from information stored on a cartridge, CD, DVD, Blu-Ray disc, or an HD DVD disk. If the content source 104 is a web server, the content stream may be generated from information stored electronically on a computer-readable storage medium accessible by the web server. Further, the content stream may be generated on-demand in response to a request from the electronic device 102. In that regard, the communication path 106 may allow one-way or two-way communications.

The content stream provided by the content source 104 may be provided on-demand or pursuant to a fixed broadcast schedule. For example, in the case where the content source 104 is a web server, the content stream may be provided in response to a request from the electronic device 102. If the content source 104 is a television station or a radio network, the content stream may be broadcast pursuant to a fixed broadcast schedule. If the content source 104 is a gaming system, the content stream may be provided after the gaming system is turned on and the appropriate game is installed into the gaming system.

The content source 104 may provide the content stream in any one of a wide variety of media formats as is known to one having ordinary skill in the art. The only restriction on the formatting of the content stream is that it must be compatible for rending on the electronic device 102. Suitable formats for the content stream include all audio, video, media, proprietary, and other formats now known or known in the future. Suitable formats, include, without limitation, NTSC, HTML, DTV, AVI, Windows Media, MPEG-1, MPEG-2, MPEG-4, QuickTime, RealVideo, Flash and Shockwave. Other suitable formats include audio formats such as AAC, AC3, MID1, MP3, RealAudio, Waveform, and WMA. Other suitable formats include image formats such as BMP, GIF, JPG, JPG 2000, MNG, PNG, SVG, TIFF. Other suitable formats include ASCII, DOC, EBCDIC, HTML, OEBPS, RTF, Unicode, WPD, and XML. Still other suitable formats include the CD, DVD, Blue-Ray, and HD DVD formats. Further, it will be noted that the content stream may be first received at an intermediary device, such as a decoder, router, gateway, satellite receiver, a cable receiver, or a high definition receiver, and then delivered to the electronic device 102.

In an embodiment of the present disclosure, the content stream provided by the content source 104 may comprise at least one of programming and advertising. In an embodiment of the present disclosure, the content stream may comprise only one of programming and advertising. As used herein, the term “programming” may refer to content that a user of the electronic device 102 wishes to access, and may include, without limitation, shows, movies, websites, games, graphical user interfaces, operating systems and music. The term “advertising,” as used herein, may refer to a paid or unpaid promotion for goods, services, companies and ideas by an advertiser. In addition, the term “advertising,” may refer at any type of solicitation of any kind.

In addition to receiving a content stream from the content source 104, the electronic device 102 may transmit and receive communications from the centralized management system 110 over a communication path 108. In an embodiment of the present disclosure, the centralized management system 110 may be located at a remote location, thereby requiring that the communication path 108 comprise a communications network. Suitable networks for the communication path 108 may include, without limitation, a computer network such as a local area network (“LAN”) or a wide area network (“WAN”). In an embodiment of the present disclosure, the communication path 108 may comprise a packet-switched network, such as the Internet. In an embodiment of the present disclosure, the communication path 108 may comprise a telephony network, such as a 3G network.

The communication path 108 between the centralized management system 110 and the electronic device 102 may be direct or indirect. Further, the communication path 108 may use any one of a wide variety of transmission mediums, including a wireless communication path, a wired communication path, or a combination of both, and may span one or more different networks. The electronic device 102 and the centralized management system 110 may use the appropriate communications protocol to communicate with each other as is known by one having ordinary skill in the art.

In an embodiment of the present disclosure, at least one user of the electronic device 102 may be required to complete an enrollment process with the centralized management system 110. In an embodiment of the present disclosure, multiple users of the electronic device 102 may be required to enroll with the centralized management system 110. For example, all of the members of a household may be required to enroll with the centralized management system 110 as users of the electronic device 102.

The enrollment process may be completed through a wide variety of methods, including through the electronic device 102 itself, another electronic device, a live interview, or through completing a paper form. A graphical user interface, such as an interactive webpage or display, may be employed to assist in the enrollment process. In an embodiment of the present disclosure, the enrollment process may require that users complete a profile assessment by providing information in response to survey-type questions.

The enrollment process may obtain demographic information about users associated with the electronic device 102. In an embodiment of the present disclosure, the enrollment process may gather information regarding the ages of users, the sexes of users, the incomes of users, the marital and family status of users, the races of users, the residences of users, the native languages of users, credit information of users, the hobbies of users, the general and specific interests of users, and/or any other information deemed necessary to direct targeted advertisements to users as is known to one have ordinary skill in the art.

The profile and demographic information gathered from users may be stored in a database associated with the centralized management system 110. The information may be used to generate user profiles for each user of the electronic device 102. In an embodiment of the present disclosure, the enrollment process may also require a user to submit a biometric or non-biometric reference sample to be used in identifying the user.

As will now be explained in greater detail, in some embodiments, the centralized management system 110 is able to deliver targeted advertisements to users of the electronic device 102 based upon the users' profiles. As used herein, the term “targeted advertisement” means an advertisement intended for a consumer having a specific profile or fitting a certain demographic in contrast to mass advertising. The targeted advertisements may be supplied to the centralized management system 110 from an advertising source 112. Once received at the centralized management system 110, the advertisements maybe stored and maintained for future dissemination to the electronic device 102.

It will be appreciated that the advertising source 112 may be operated by a third-party, such as an advertising agency or by an in-house marketing department of a company. The advertising source 112 and the centralized management system 110 may engage in communications over a communication path 114. Through the communication path 114, the advertising source 112 may transmit the targeted advertisements to the centralized management system 110. The targeted advertisements may be provided by the advertisement source 112 in a format suitable for transmission to the electronic device 102 by the centralized management system 110. Alternatively, the centralized management system 110 may have the capability to format or re-format a targeted advertisement for transmission to the electronic device 102 over the communication path 108. Further, the targeted advertisements may be provided to the centralized management system 110 on a portable storage medium, such as a CD or DVD.

In addition to the targeted advertisements, the advertisement source 112 may provide target profiles associated with each of the targeted advertisements. The target profiles may define a desired target profile of a user to whom the targeted advertisements are directed. The target profiles for the targeted advertisements may be developed by using profile information, which may contain demographic and behavioral information, stored at the centralized management system 110.

Once a targeted advertisement and its associated target profile have been received at the centralized management system 110, the centralized management system 110 may execute an operation to compare the target profile for the advertisement to the profiles of some or all of the enrolled users to thereby determine a group of targeted users to whom the targeted advertisement should be delivered. It will be appreciated by those having ordinary skill in the art that the profiles of the targeted users may be only a close match to the target profile and that an exact match is not required between the target profile and a user's profile. In an embodiment of the present disclosure, there is a 90% or higher match between the target profile and a user's profile in order for the user to be targeted. In an embodiment of the present disclosure, there is an 80% or higher match between the target profile and a user's profile in order for the user to be targeted. In an embodiment of the present disclosure, there is a 70% or higher match between the target profile and a user's profile in order for the user to be targeted.

The targeted advertisement provided by the advertising source 112 may include a promotion for a product or service. The targeted advertisement may comprise a political advertisement or some other solicitation. In an embodiment of the present disclosure, the targeted advertisement may include contact information that allows a user to immediately place an order from a service center 118. The contact information may include a telephone number, or in the case where the targeted advertisement is presented online, a link to a live chat center. In an embodiment of the present disclosure, the contact information is understood to allow a user to be placed in direct contact with a customer service agent or a live person at the service center 118.

In an embodiment of the present disclosure, when a user of the electronic device 102 is found to have a profile that corresponds to a target profile associated with a targeted advertisement, the centralized management system 110 may cause the targeted advertisement to be disseminated to the electronic device 102 via the communication path 108. The targeted advertisement may not be immediately rendered, but may instead be stored locally to the electronic device 102 for future rendering. Data associated with the targeted advertisement, and transmitted to the electronic device 102, may specify the specific user of the electronic device 102 to whom the targeted advertisement is to be rendered. Thus, each targeted advertisement may be linked to at least one known user of the electronic device 102.

In an embodiment of the present disclosure, non-targeted advertisements may be disseminated from the centralized management system 110 to the electronic device 102. It will be appreciated that as used hereinafter, the term “advertisement” may refer to targeted advertisements, non-targeted advertisements, or both. It will be further appreciated that because the advertisements are separate from a content stream from the content source 104, the centralized management system 110, the electronic device 102, or both, may regulate their placement into the content stream. As used herein, the term “regulate” may mean to control the timing at which the advertisements are rendered on the electronic device 102.

In an embodiment of the present disclosure, the advertisements may be maintained and stored at the electronic device 102 until a rendering command is received from the centralized management system 110. In particular, the rendering command may specify that an advertisement be rendered at the next available opportunity or at some other specified future time. In an embodiment of the present disclosure, the centralized management system 110 may transmit a do not render command to the electronic device 102 instructing it not to render a particular advertisement that has been previously scheduled to be rendered.

In an embodiment of the present disclosure, the regulation of the rendering of advertisements by the centralized management system 110 may be dictated by service levels at the service center 118. As previously discussed, the advertisements may include direct contact information for the service center 118. The service center 118 may include a means for monitoring a service level of the center 118. In an embodiment of the present disclosure, the service center 118 may monitor the number of inbound communications from consumers to determine the service level. In an embodiment of the present disclosure, the service center 118 may monitor consumer wait times to determine the service level. It will be appreciated that it is within the scope of the present disclosure to utilize any criteria for determining a service level at the service center 118.

As conceptualized herein, a high service level indicates that consumers are experiencing a high satisfaction with the ordering experience from the service center 118. A high service level may indicate that wait times may be minimal, and that there is a low incidence of consumers abandoning the ordering process. As conceptualized herein, a low service level may indicate that consumers are experiencing a low satisfaction with the ordering experience. A low service level may indicate that wait times may be significant, and that there is a high incidence of consumers abandoning the ordering process without communicating with a customer service agent.

The service center 118 may provide information to the centralized management system 110 regarding the state of its service level via a communication path 116. The information may indicate whether the service level at the service center is high or low. Based upon the information from the service center 118, the centralized management system 110 may regulate the rendering of advertisements on the electronic device 102. In the case where the service level is high, the centralized management system 110 may not interfere with a scheduled rendering of the advertisement or send a rendering command instructing that the advertisement be rendered as soon as possible. In the case where the service level is low, the centralized management system 110 may delay in sending a rendering command or send a do not render command instructing that a previously scheduled rendering of the advertisement not take place. In this manner, it will be appreciated that the centralized management system 110 may dynamically regulate the rendering of advertisements on the electronic device 102 to maintain acceptable service levels at the service center 118.

In an embodiment of the present disclosure, the centralized management system 110 may regulate the rendering of advertisements on multiple electronic devices using a predetermined rendering schedule. That is, the centralized management system 110 may cause the multiple electronic devices to render advertisements at staggered intervals or at a predetermined rate such that the service level at the service center 118 remains at an acceptable level. In an embodiment of the present disclosure, the centralized management system 110 may utilize a predictive algorithm in order to generate a rendering schedule. For example, a rendering schedule may dictate that an advertisement is rendered on a specified number of electronic devices over a specified period of time.

Once the rendering of an advertisement stored at the electronic device 102 is determined to occur, the electronic device 102 may begin monitoring a content stream from the content source 104 for an advertisement placement opportunity. If the advertisement is a targeted advertisement, the electronic device 102 may be first required to confirm that the targeted user is actually using the electronic device 102. Once an advertisement placement opportunity is recognized in relation to a content stream, and all other factors are satisfied, the electronic device 102 may render the advertisement to the user. The user will then have the opportunity to contact the service center 118 through the contact information provided in the advertisement to take an action in accordance with the advertisement, such as place an order for a product or service or to simply receive information or take some other action.

It will be appreciated that as used herein, the concept of a “service center” should be construed broadly to include any facility or system able to receive inbound inquiries from members of the public through any medium. In some instances, a service center may be staffed by live agents, but not necessarily. Further, a service center need not necessarily take orders for products and services from consumers, but may instead provide information or take donations, for example, in response to inbound communications.

It will be appreciated that although only one advertisement source 112 is depicted in FIG. 1, that the centralized management system 110 may receive advertisements from multiple advertisement sources. In this manner, the centralized management system 110 is able to deliver advertisements from multiple advertisement sources to the electronic device 102. Further, it will be appreciated by those having ordinary skill in the art, that multiple users may enroll with the centralized management system 110 for the electronic device 102. Moreover, although only one electronic device 102 is depicted in FIG. 1, it will be appreciated by those having ordinary skill in the art that multiple electronic devices, each having one or more users, may receive advertisements from the centralized management system 110. Further, the electronic devices in contact with the centralized management system 110 may take a variety of form factors. In this manner, the centralized management system 110 is able to deliver advertisements across multiple platforms to multiple users. Further, the centralized management system 110 may be able to maintain acceptable service levels at the service center 118 during a large advertising campaign conducted across multiple platforms.

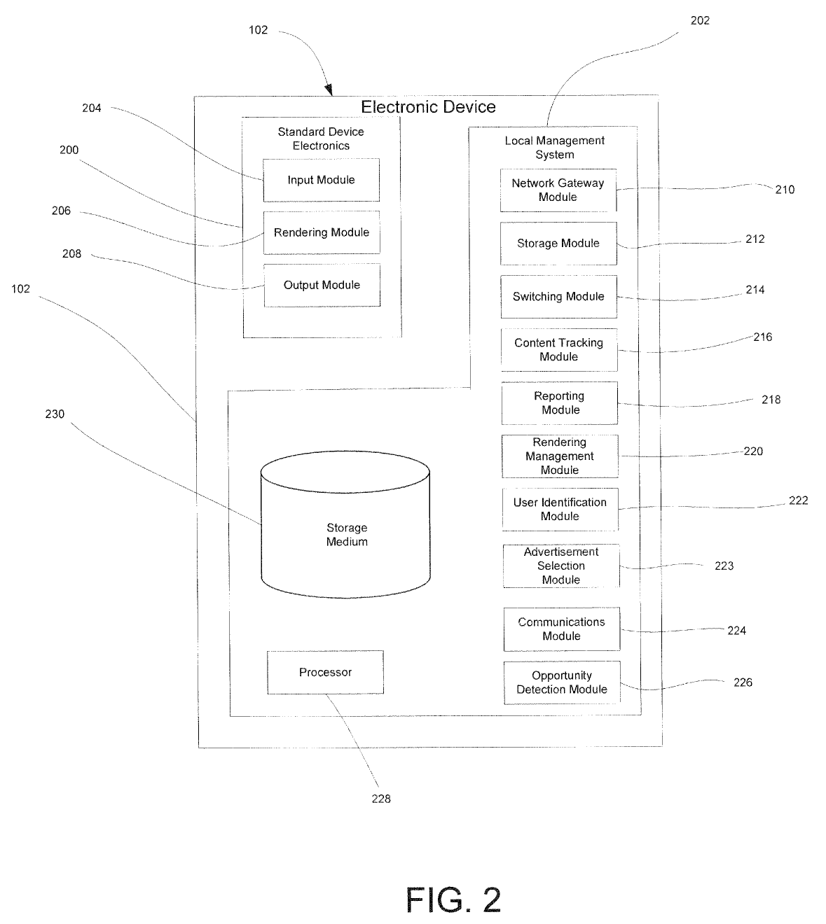

Referring now to FIG. 2, there is illustrated a diagram of the logical and other components of the electronic device 102 pursuant to an embodiment of the present disclosure. As previously mentioned, the present disclosure is not limited to any particular type of electronic device 102. An electronic device 102 may comprise, without limitation, televisions, cellular phones, computers, personal digital assistants and portable music players. Thus, it is to be understood by those having ordinary skill in the art that the features disclosed in relation to FIG. 2 may be incorporated into a wide range of electronic devices having the ability to render a content stream.

The electronic device 102 may include standard device electronics 200 and a local management system 202. The standard device electronics 200 may be those components typically associated with the type of electronic device 102. For example, if the electronic device 102 is a television, then the standard device electronics 200 may include those components typically found in a conventional television. Likewise, if the electronic device 102 is a computer, then the standard device electronics 200 may include those components typically found in a conventional computer. Additionally, if the electronic device 102 is a cellular phone, then the standard device electronics 200 may be those components typically found in a cellular phone.

In an embodiment of the present disclosure, the standard device electronics 200 may include an input module 204, a rendering module 206, and an output module 208. The input module 204 may be operable to receive a signal carrying a content stream from the content source 104 and may comprise all the necessary circuitry and related software to accomplish this task as is known to one having ordinary skill in the art. For example, if the content stream is received via a wireless connection, then the input module 204 may include an antenna and associated radio frequency circuitry, including a radio receiver chipset, necessary to receive the signal. Likewise, if the content stream is received via a wired connection, the input module 204 may include the appropriate connection jacks and the necessary circuitry and software to accomplish this task. The input module 204 may include a modem, a network card, and any other circuitry, hardware, decoder, and software necessary to receive the content stream.

The rendering module 206 may be operable to transform the content stream from the received form into an appropriate form compatible with the output module 208. The rendering module 206 may render both digital and analog signals. The output module 208 may comprise a display, including an electronic display, screen, monitor, and/or speakers. The output module 208 may allow a user to actually perceive the content stream as rendered by the rendering module 206. It will be appreciated that the structure and apparatus disclosed herein is merely one example of a means for displaying an advertisement, and it should be appreciated that any structure, apparatus or system for displaying an advertisement which performs functions the same as, or equivalent to, those disclosed herein are intended to fall within the scope of a means for displaying an advertisement, including those structures, apparatus or systems for displaying an advertisement which are presently known, or which may become available in the future. Anything which functions the same as, or equivalently to, a means for displaying an advertisement falls within the scope of this element.

The local management system 202 may include the various components as will now be described. A network gateway module 210 may be operable to allow communications between the electronic device 102 and the centralized management system 110. In an embodiment of the present disclosure, the network gateway module 210 may comprise a connection to a LAN or a WAN. In an embodiment of the present disclosure, the network gateway module 210 may allow communications to be received and transmitted over a network, such as the Internet. In particular, the network gateway module 210 may facilitate the communications with the centralized management system 110 over the communication path 108 (see FIG. 1).

The advertisements may be received through the network gateway module 210. In addition, any commands to regulate the rendering of the advertisements may be received through the network gateway module 210. In an embodiment of the present disclosure, the network gateway module 210 and the input module 204 may share components if the communication paths between the content source 104 and the centralized management system 110 are the same. In an embodiment of the present disclosure, the network gateway module 210 may comprise at least one of a modem, a network card and a high speed Internet connection.

The storage module 212 may be operable to control the storage of information in a digital storage medium 230 and may include the appropriate software and hardware drivers to effectuate the same. The information stored on the storage medium 230 may include advertisements and one or more content streams, as well as any other needed information or computer programming required to accomplish the tasks described herein.

It will be appreciated that the structure and apparatus disclosed herein is merely one example of a means for electronically storing an advertisement, and it should be appreciated that any structure, apparatus or system for electronically storing an advertisement which performs functions the same as, or equivalent to, those disclosed herein are intended to fall within the scope of a means for electronically storing an advertisement, including those structures, apparatus or systems for electronically storing an advertisement which are presently known, or which may become available in the future. Anything which functions the same as, or equivalently to, a means for electronically storing an advertisement falls within the scope of this element.

A switching module 214 may be operable to cause that the advertisements received from the centralized management system 110 are rendered on the electronic device 102 according to advertisement placement opportunities. In an embodiment of the present disclosure, the switching module 214 may comprise a switch capable of switching between the content stream from the content source 104 and the advertisements stored on the storage medium 230. Thus, the switching module 214 may dynamically switch back and forth the source for the rendering module 206 between the content stream from the content source 104 and the advertisements.

It will be appreciated that the structure and apparatus disclosed herein is merely one example of a means for switching between a content stream and an advertisement, and it should be appreciated that any structure, apparatus or system for switching between a content stream and an advertisement which performs functions the same as, or equivalent to, those disclosed herein are intended to fall within the scope of a means for switching between a content stream and an advertisement, including those structures, apparatus or systems for switching between a content stream and an advertisement which are presently known, or which may become available in the future. Anything which functions the same as, or equivalently to, a means for switching between a content stream and an advertisement falls within the scope of this element.

A content tracking module 216 may track and record information regarding the content stream into which the advertisements are placed. In an embodiment of the present disclosure, the content tracking module 216 may extract and record embedded codes in the content stream from the content source 104. These embedded codes may then be transmitted to centralized management system 110 where the content provider and/or content owner of the content stream from the content source 104 may be identified using the codes. In another embodiment, the content tracking module 216 may also simply track and record the time and the specific channel that carries the content stream. This information may then be transmitted to the centralized management system 110 where the content provider and/or content owner may be identified.

In an embodiment of the present disclosure, the content tracking module 216 may record the internet address of a website into which the advertisements are placed. This information may then be transmitted to the centralized management system 110. In an embodiment of the present disclosure, the content tracking module 216 may also create a map of the data in the content stream. The map of the data may then be transmitted to the centralized management system 110 where the content provider and/or content owner may be identified using the data map. It will be appreciated by those having ordinary skill in the art that any process or methodology now known or known in the future that is used to identify the owner or provider of a content stream falls within the scope of the present disclosure.

A reporting module 218 may generate feedback and other information transmitted to the centralized management system 110. The feedback may include, for example, information verifying the rendering of a targeted advertising to the targeted user.

A rendering management module 220 may insure that the advertisements are rendered according to any delivery requirements sent by the centralized management system 110. In an embodiment of the present disclosure, the delivery requirements may set the sequence in which the advertisements are rendered to a user. The delivery requirements may also specify where in the content stream that the targeted advertisements should be placed, e.g., first viewed, second viewed, etc. Further, the rendering management module 220 may receive commands to render or not to render an advertisement from the centralized management system 110, including a render command and a do not render command. The rendering management module 220 may receive a predetermined schedule pursuant to which the advertisement should be rendered. As explained above, these commands and schedules may be related to a service level at the service center 118. In an embodiment of the present disclosure, these commands may specify a time period in the future in which an advertisement should be rendered.

It will be appreciated that the structure and apparatus disclosed herein is merely one example of a means for dynamically regulating the rendering of the advertisements, and it should be appreciated that any structure, apparatus or system for dynamically regulating the rendering of the advertisements which performs functions the same as, or equivalent to, those disclosed herein are intended to fall within the scope of a means for dynamically regulating the rendering of the advertisements, including those structures, apparatus or systems for dynamically regulating the rendering of the advertisements which are presently known, or which may become available in the future. Anything which functions the same as, or equivalently to, a means for dynamically regulating the rendering of the advertisements falls within the scope of this element.

It will be further appreciated that the structure and apparatus disclosed herein is merely one example of a means for receiving a command signal operable to cause an advertisement to be rendered, and it should be appreciated that any structure, apparatus or system for receiving a command signal operable to cause an advertisement to be rendered which performs functions the same as, or equivalent to, those disclosed herein are intended to fall within the scope of a means for receiving a command signal operable to cause an advertisement to be rendered, including those structures, apparatus or systems for receiving a command signal operable to cause an advertisement to be rendered which are presently known, or which may become available in the future. Anything which functions the same as, or equivalently to, a means for receiving a command signal operable to cause an advertisement to be rendered falls within the scope of this element.

A user identification module 222 may be operable to identify the user of the electronic device 102. The user identification module 222 may include integrated technologies that passively identify the user of the electronic device 102. As used herein, the term “passively” means that a user is not actively aware of the operation of the user identification module 222 or that the electronic device 102 does not require a specific user input to trigger the delivery of any targeted advertisements.

In an embodiment of the present disclosure, the user identification module 222 utilizes biometric recognition technologies and techniques. Suitable biometric recognition technology includes fingerprint recognition, retina recognition, heartbeat recognition, voice recognition, face recognition, and any other technology now known or known in the future that utilizes a measurable, physical characteristic or personal behavioral trait that may be used to recognize the identity, or verify the claimed identity, of a user. Other passive identification options for non-biometric technologies and techniques include associating a specific user with a cellular phone number, a serial number of an electronic device, or IP address assigned to an electronic device. The user identification module 222 may then identify a user based on the proximity of a known user mobile device associated with a specific cellular phone number, serial number, or IP address. The user identification module 222 may also use active identification technologies such as passwords, logins, and challenge questions to identify the user.

In the case where the user identification module 222 employs a biometric recognition technology, prior enrollment by the user may be required. That is, a user may be required to submit a reference sample of the characteristic or trait used to identify the user as previously described. Once taken, the reference sample may be stored at the centralized management system 110 or in the storage medium 230. The reference sample may be disseminated to the electronic device 102 associated with the user through the communication path 108. It will be appreciated that the reference sample for a user may be disseminated to multiple electronic devices 102 such that the user may only have to provide the sample one time.

The user identification module 222 may include the necessary components to capture the user's characteristic or trait. For example, in the case where the biometric technology utilizes finger print recognition, the user identification module 222 may include a fingerprint scanner. After the user's fingerprint is scanned, the scan is compared to the reference sample to thereby identify the user.

After a user's identity is confirmed, or, stated another way, the user of the electronic device 102 is confirmed to have previously enrolled with the centralized management system 110, an advertisement selection module 223 determines if any targeted advertisements on the storage medium 230 are linked to that user. If a targeted advertisement is linked to the current user of the electronic device 102, the advertisement selection module 223 may notify the switching module 214 and an opportunity detection module 226 of a targeted advertisement that needs placement. If there are no targeted advertisements, the advertisement selection module 223 may not take any action.

A communications module 224 is operable to control communications between the electronic device 102 and the centralized management system 110 through the network gateway module 210.

The opportunity detection module 226 may be operable to recognize advertisement placement opportunities in relation to a content stream from the content source 104. For example, the opportunity detection module 226 may identify an advertising placement opportunity in a content stream for an advertisement received from the centralized management system 110. In order to identify an advertisement placement opportunity, the opportunity detection module 226 may monitor the content stream for embedded codes that signal an upcoming slot designated for advertising. The embedded codes may take the form of an inaudible tone or any other type of signaling or flag. Once an upcoming slot designated for advertising has been identified, the opportunity detection module 226 may cause that the original advertisements in the content stream be displaced by the advertisements from the centralized management system 110 using the switching module 214. If the content stream is HTML coding that defines a webpage, the opportunity detection module 226 may swap out a banner ad in the content stream with an advertisement, also a banner ad, from the centralized management system 110.

It will be appreciated that the structure and apparatus disclosed herein is merely one example of a means for determining an advertisement placement opportunity for the advertisement, and it should be appreciated that any structure, apparatus or system for determining an advertisement placement opportunity for the advertisement which performs functions the same as, or equivalent to, those disclosed herein are intended to fall within the scope of a means for determining an advertisement placement opportunity for the advertisement, including those structures, apparatus or systems for determining an advertisement placement opportunity for the advertisement which are presently known, or which may become available in the future. Anything which functions the same as, or equivalently to, a means for determining an advertisement placement opportunity for the advertisement falls within the scope of this element.

The local management system 202 may include a microprocessor 228, also known as a centralized processing unit. As the various modules 210-226 may include computer programming code, the modules 210-226 may utilize the microprocessor 228 to accomplish their intended purposes as outlined herein. In an embodiment of the present disclosure, the microprocessor 228 may be incorporated into the modules 210-226.

It will be appreciated that the local management system 202 may be integrated into the electronic device 102 or may be contained in a separate and stand-alone unit having a connection to the electronic device 102, i.e., the standard device electronics 200. It will further be noted that any of the modules 210-226 may also be integrated into the electronic device 102, or any or all of them may be externally located with respect to the electronic device 102. Further, an omission of any of the modules 210-226 in an electronic device 102 still falls within the scope of the present disclosure. That is, embodiments of the present disclosure may have less than all of the modules 210-226 shown in FIG. 2. Further, the modules 210-226 may share common resources, including software and hardware, without departing from the scope of the present disclosure.

It will be appreciated that the structure and apparatus disclosed herein is merely one example of a means for rendering an advertisement, and it should be appreciated that any structure, apparatus or system for rendering an advertisement which performs functions the same as, or equivalent to, those disclosed herein are intended to fall within the scope of a means for rendering an advertisement, including those structures, apparatus or systems for rendering said advertisement which are presently known, or which may become available in the future. Anything which functions the same as, or equivalently to, a means for rendering an advertisement falls within the scope of this element.

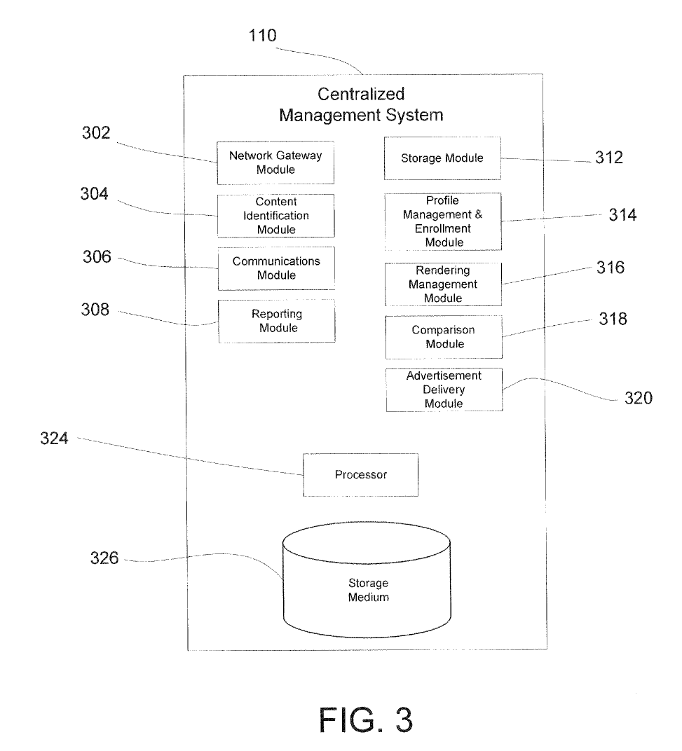

Referring now to FIG. 3, there is illustrated a diagram of the logical and other components of an exemplary embodiment of a centralized management system 110. As mentioned above, the centralized management system 110 may be remotely located from the electronic device 102 such that the centralized management system 110 is able to communicate with a plurality of electronic devices over a network. Indeed, it will be appreciated the centralized management system 110 may connect to thousands or millions of electronic devices. Each of the various components of the centralized management system 110 will now be described.

A network gateway module 302 may be operable to allow communications between the electronic device 102 and the centralized management system 110. The network gateway module 302 may comprise a connection to a network, such as a LAN or a WAN. In an embodiment of the present disclosure, the network gateway module 302 may allow communications to be received and transmitted over a network such as the Internet or a proprietary network. The network gateway module 302 may also allow communications with the advertisement source 112 and the service center 118 as described herein.

A content identification module 304 may be operable to identify the content provider and/or the content owner of a content stream into which an advertisement is placed. The content identification module 304 may use information gathered by the content tracking module 216 of electronic device 102 and transmitted to the centralized management system 110 in order to identify the content provider and/or content owner of the content stream. The content identification module 304 may identify the content provider and/or content owner of the content stream using any one of a variety of methods described below.

In an embodiment of the present disclosure, a content provider and/or content owner of the content stream may be identified using codes embedded in the content stream. The embedded codes may be extracted from the content stream by the electronic device 102. Once extracted, the codes may then be transmitted to the centralized management system 110 using communication path 108. The content identification module 304 may then use the codes to properly identify the content provider and/or content owner of the content stream. Alternatively, the content identification module 304 may utilize a data point map extracted from the content stream and transmitted to the centralized management system 110 by the electronic device 102. The content identification module 304 may then compare this map to known maps to identify the content owner and/or content provider. In another embodiment, the electronic device 102 may log the time and channel on which the content stream is broadcast and transmit this information to the centralized management system 110. The content identification module 304 may then compare this information to a programming schedule to identify the content owner and/or content provider.

A communications module 306 is operable to control communications between the electronic device 102 and the centralized management system 110, the centralized management system 110 and the advertisement source 112, and the centralized management system 110 and the service center 118. For example, the communications module 306 may identify preferred communication times to download the advertisements to the electronic device 102. The communication module 306 may track successful and unsuccessful communications and repeat as necessary. The communication module 306 may be completely autonomous from human interaction such that the communications with the electronic device 102 occur automatically. The communications module 306 may send the communications through the network gateway module 306.

A reporting module 308 may be operable to generate reports regarding the advertisement placing and any revenue sharing with those content providers identified by the content tracking module 304. The reports may be generated automatically pursuant to a reporting policy established by the operators of the centralized management system 110. The reports generated by the reporting module 308 may include information received from the reporting module 218 on the electronic device 102.

The centralized management system 110 may include a storage module 312 that is operable to manage and control the storage of information in a storage medium 326. The storage module 312 may include a database management application suitable for the purposes outlined herein. The storage module 312 may include the appropriate software drivers for accessing information from the storage medium 326.

The centralized management system 110 may include a user profile management and enrollment module 314 that may be operable to receive and manage user profiles in the storage medium 326. A user profile may include demographic information regarding a user of the electronic device 102. The user profile management and enrollment module 314 may administer an on-line profile assessment to a user thereby enroll a user with the centralized management system 110. The user profile management and enrollment module 314 may also receive and store biometric reference samples from users as part of the users profile. In addition, the user profile management and enrollment module 314 may also associate all of the electronic devices of a user with the user's profile.

The centralized management system 110 may include a rendering management module 316 that may be operable to dynamically regulate the rendering of advertisements on the electronic device 102. The centralized management system 110 may receive information from the service center 118 regarding a service level at the service center 118. The information may comprise an indication of whether the service level is high or low. For example, if the service center 118 is an inbound call center, the acceptable service level may be a call wait time of less than one minute. If the wait is longer than one minute, then the service level may be considered unacceptable.

When the rendering management module 316 is informed that the service level at the service center 118 is acceptable, it may cause a rendering command to be transmitted to the electronic device 102. The rendering command may cause the electronic device 102 to render the advertisement at the next available opportunity. When the rendering management module 316 is informed that the service level at the service center 118 is unacceptable, it may cause that the advertisement not be rendered through either not sending the rendering command or sending a do not render command if the rendering of the advertisement has already been prescheduled. In this manner, the centralized management center 110 may insure that new inbound calls or communications are only received at the service center when the service level is acceptable.

It will be appreciated that the above description can be applied on a much larger scale. In this manner, the present disclosure is able to keep service levels of the service center 118 at acceptable levels by dynamically controlling the rendering of advertisements on a plurality of electronic devices. As mentioned, the advertisements typically relay contact information in order to allow a user to place a request for products or services. By dynamically regulating the timing of the rendering of the advertisements across a plurality of electronic devices, the present disclosure may indirectly regulate the number of inbound communications to the service center 118, assuming a predictable response rate. The present disclosure may therefore be able to improve service levels, lower costs, and raise service quality by regulating the timing of the rendering of advertisements.

At times when the service center 118 may be too busy to accept new inbound communications, the centralized management system 110 may prevent the electronic device 102 from rendering the advertisement. At times when the service center 118 may not be too busy, the centralized management system 110 may allow the electronic device 102 to render the associated advertisement. This process may be facilitated since the advertisement may be stored locally at the electronic device 102. In this manner, the present disclosure may allow the service center 118 to be fully optimized at all times to thereby greatly increase the productivity and profitability of the service center 118. In an embodiment of the present disclosure, the service center 118 may not be affiliated with the centralized management system 110 and may instead be operated by a third party. The third party may then compensate the operators of the centralized management system 110 for the use of the features of the present disclosure.

In the past, it is believed that the regulation of the rendering of advertisements based upon a service level at a service center as described herein was impossible. In particular, service centers often experienced a peak of inbound communications just after an advertisement was rendered through a traditional mass advertising method. Inbound communications are often lost due to excessive wait times and customer service deteriorates as customer service agents become swamped. Further, as discussed above, service centers must staff for large rushes of inbound communications during peak times, but most of the time, the staff is underutilized and standing idle. Further, the large rush of calls may exceed the number of available lines. (In the case where the service center is contacted via the Internet, a large number of requests from users may exceed the available bandwidth.)

The rendering management module 316 may allow for the delivery of the advertisements to be staggered, or rendered at a predetermined rate, to users of electronic devices such that the service level at the service center consistently remains at or near an acceptable level. As a result of the value provided by the present disclosure, advertisers may be willing to pay a higher premium for controlling the timing of the rendering of their advertisements.

The centralized management system 110 may include a comparison module 318 that is operable to compare the target profiles for any targeted advertisements to the user profiles to thereby determine a group of targeted users. At this point, the centralized management system 110 may generate feedback to the advertisement source 112 regarding the group of targeted users. This feedback may include the information regarding the number of users in the group of targeted users. This information may allow the modification of the target profile such that the size of the group of targeted users may be increased or decreased. This process may undergo several iterations until a desired group of targeted user profiles has been generated.

Once the targeted users have been identified and finalized by the comparison module 318, the centralized management system 110 may disseminate the targeted advertisements to an electronic device 102 associated with each of the targeted users via the advertisement delivery module 320. The advertisement delivery module 320 may also transmit a link associated with a targeted advertisement. The link may identify the targeted user to whom the targeted advertisement is to be directed. In this manner, the electronic device 102 may utilize the link to ensure proper delivery of the targeted advertisement to the targeted user.

It should be noted that users who do not have a matching profile to the targeted profile may not receive the targeted advertisements. The dissemination of the targeted advertisements to the electronic devices 102 of the targeted users may take place as the system demands allow. Typically, this may occur during off-peak hours. Further, the process may occur over several hours, days or weeks depending upon the size of the group of targeted users.

The centralized management system 110 may include a processor 324, also known as a central processing unit or microprocessor, that is operable to process any of the required data from any of the modules 302-320. The processor 324 may take any one of a variety of forms including a single processor or multiple processors. Further, it will be appreciated that the centralized management system 110 may be integrated into a single computing device or may be distributed across multiple computing platforms. It will further be noted that the modules 302-320 may also be integrated into a single computing device or maybe separately located amongst multiple computing platforms. Further, omission of any of the modules 302-318 falls within the scope of the present disclosure. That is, alternative embodiments of the present disclosure may have less than all of the modules 302-320 shown in FIG. 3.

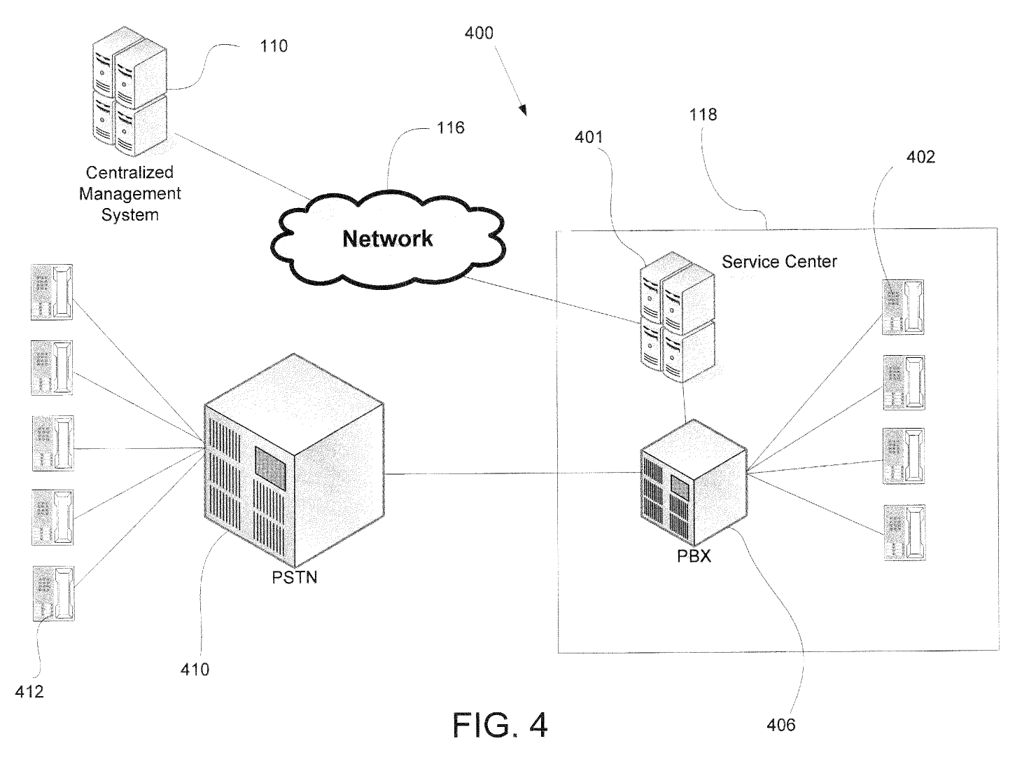

Referring now to FIG. 4, there is depicted a system 400 pursuant to an embodiment of the present disclosure. The service center 118 may comprise a private branch exchange or PBX 406. The PBX 406 may be a telephone system within an enterprise that switches calls between enterprise users on local telephones 402. The PBX may be connected to a public switched telephone network or PSTN 410. The PSTN 410 may route calls from telephones 412, which may be used by consumers to contact the service center 118. The PBX 406 may be especially suited for use in association with an inbound call center and may provide a call queue for placing inbound calls on hold until the next free line is available.

A computer system 401 may be connected to the PBX 406 in order to determine and monitor a service level of the service center 118. It will be understood that the term “service level” may mean the ability of the service center 118 to respond to new inbound communications. A predetermined service threshold, including wait times, may determine when a service level is acceptable or unacceptable, i.e., high or low. The computer system 401 may be connected to the centralized management system 110 via communication path 116, which may be a network. The computer system 401 may provide information to the centralized management system 110 regarding the service level at the service center 118. As explained previously, the centralized management system 110 may utilize the information regarding the service level at the service center 118 to regulate the rendering of advertisements. The computer system 401 may include a monitoring module for determining the service level at the service center 118. The monitoring module may employ any method now known or known in the future to monitor a service level at the service center 118, including queuing models based on queuing theory or any other technique as is now known or known in the future to one having ordinary skill in the art.

It will be appreciated that the structure and apparatus disclosed herein is merely one example of a means for monitoring a service level at a service center, and it should be appreciated that any structure, apparatus or system for monitoring a service level at a service center which performs functions the same as, or equivalent to, those disclosed herein are intended to fall within the scope of a means for monitoring a service level at a service center, including those structures, apparatus or systems for monitoring a service level at a service center which are presently known, or which may become available in the future. Anything which functions the same as, or equivalently to, a means for monitoring a service level at a service center falls within the scope of this element.

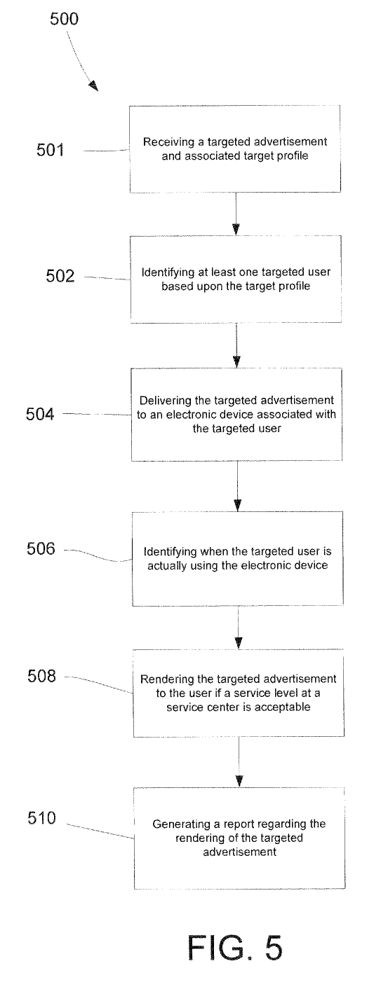

Referring now to FIGS. 1 and 5, there is depicted a flow diagram 500 according to an embodiment of the present disclosure. At step 501, a targeted advertisement along with an associated target profile may be received at the centralized management system 110 from the advertising source 112. The targeted advertisement and the target profile may be transmitted either separately or together over the communication path 114, such as a computer network. Alternatively, the targeted advertisement and the target profile may be delivered to the centralized management system 110 on a portable storage medium. The targeted advertisement and the target profile may then be loaded onto the centralized management system 110 for future dissemination. The centralized management system 110 may comprise a computer database having a plurality of user profiles stored therein.

At step 502, a computer application running on the centralized management system 110 compares the target profile to the user profiles in order to determine a group of targeted users. The comparison should return at least one targeted user. The targeted users may be those users who have profiles that match or are closely matched to the target profile of the advertisement.

At step 504, the targeted advertisement may be delivered to the electronic device 102 of a targeted user. This may be accomplished by transmitting the targeted advertisement from the centralized management system 110 over the communication path 108, which may be a network.

At step 506, the electronic device confirms when the targeted user is actually using the electronic device, and, at step 508, the electronic device renders the targeted advertisement to the targeted user if a service level at the service center 118 is acceptable. At step 510, a report regarding the rendering of the targeted advertisement is generated. The report may be electronically transmitted back to the centralized management system 110.

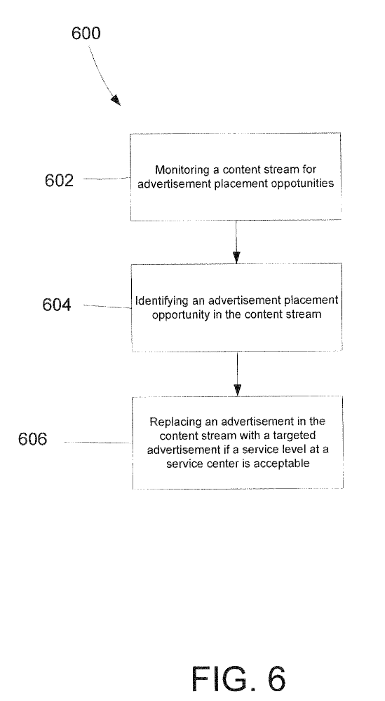

Referring now to FIG. 6, there is depicted a flow diagram 600 according to an embodiment of the present disclosure. At step 602 a content stream is monitored for an advertisement placement opportunity. At step 604, an advertisement placement opportunity is identified in the content stream. At step 606, an advertisement in the content stream is replaced with a targeted advertisement if a service level at a service center is acceptable. This may be accomplished by switching an input from a source carrying the content stream to a source carrying the targeted advertisement. In particular, the targeted advertisement may be pre-buffered such that the switch to the targeted advertisement may be accomplished on-the-fly and without interruption. After the targeted advertisement has been rendered, the source of the input may be switched back to the source carrying the content stream. This step may provide a seamless integration of the targeted advertisement into the content stream, to the extent possible, such that the switch is unnoticeable to a user.

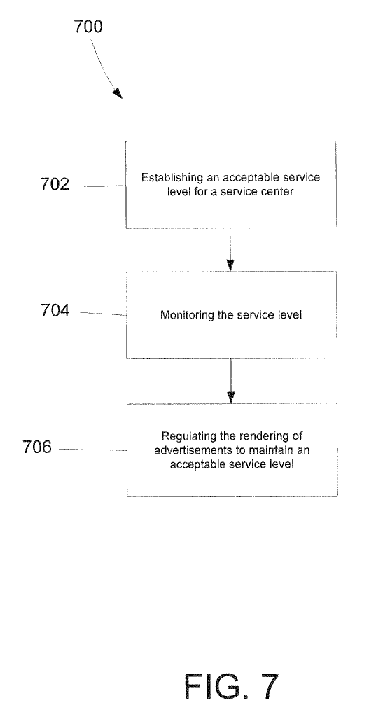

Referring now to FIG. 7, there is depicted a flow diagram 700 according to an embodiment of the present disclosure. At step 702, an acceptable service level is established for a service center. At step 704, the service level is monitored. At step 706, the rendering of advertisements are dynamically regulated in order to maintain an acceptable service level at the service center.

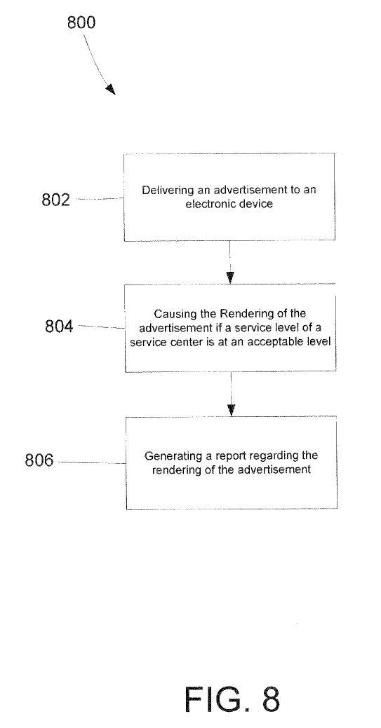

Referring now to FIG. 8, there is depicted a flow diagram 800 according to an embodiment of the present disclosure. At step 802, an advertisement is delivered and stored locally at an electronic device capable of rendering the advertisement. At step 804, the advertisement is caused to be rendered on the electronic device if a service level at a service center is at an acceptable level. At step 806, a report is generated regarding the rendering of the advertisement.

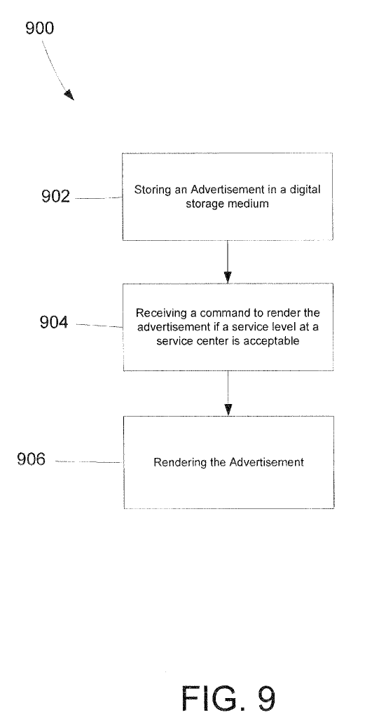

Referring now to FIG. 9, there is depicted a flow diagram 900 according to an embodiment of the present disclosure. At step 902, an advertisement is caused to be stored in a digital storage medium. At step 904, a rendering command is received to render the advertisement, wherein the rendering command is indicative that a service level at a service center is acceptable. At step 906, the advertisement is rendered.

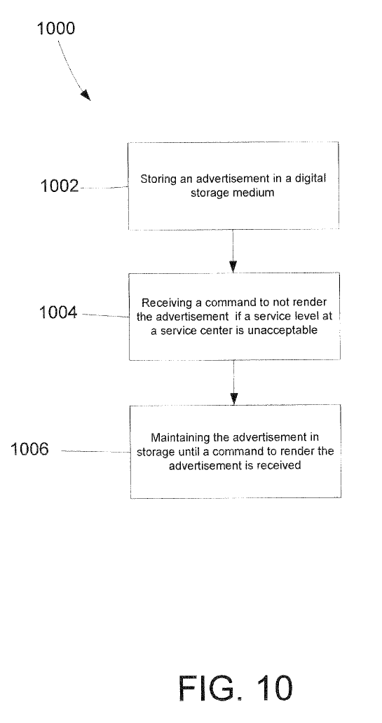

Referring now to FIG. 10, there is depicted a flow diagram 1000 according to an embodiment of the present disclosure. At step 1002, an advertisement is caused to be stored in a digital storage medium. At step 1004, a command is received to not render the advertisement, wherein the command is indicative that a service level at a service center is unacceptable. At step 1006, the advertisement is maintained in storage until a command to render the advertisement is received.

It will be appreciated that a user of an electronic device may be sometimes referred to herein as a consumer and vice versa.

Those having ordinary skill in the relevant art will appreciate the advantages provided by the features of the present disclosure. For example, it is a feature of the present disclosure to provide a system for dynamically regulating the rendering of advertisements based upon a service level at a service center. Another feature of the present disclosure is to provide a confirmation or verification that an advertisement has been rendered to a targeted user.

In the foregoing Detailed Description, various features of the present disclosure are grouped together in a single embodiment for the purpose of streamlining the disclosure. This method of disclosure is not to be interpreted as reflecting an intention that the claimed disclosure requires more features than are expressly recited in each claim. Rather, as the following claims reflect, inventive aspects lie in less than all features of a single foregoing disclosed embodiment. Thus, the following claims are hereby incorporated into this Detailed Description of the Disclosure by this reference, with each claim standing on its own as a separate embodiment of the present disclosure.

It is to be understood that the above-described arrangements are only illustrative of the application of the principles of the present disclosure. Numerous modifications and alternative arrangements may be devised by those skilled in the art without departing from the spirit and scope of the present disclosure and the appended claims are intended to cover such modifications and arrangements. Thus, while the present disclosure has been shown in the drawings and described above with particularity and detail, it will be apparent to those of ordinary skill in the art that numerous modifications, including, but not limited to, variations in size, materials, shape, form, function and manner of operation, assembly and use may be made without departing from the principles and concepts set forth herein.

What is claimed is:

1. A system for rendering advertisements on a plurality of electronic devices, comprising:
a communications module for receiving information regarding a service level at a service center;
a rendering management module for dynamically regulating the rendering of the advertisements on the plurality of electronic devices in accordance with the information; and
a microprocessor programmed to operate at least one of the management module or the rendering management module.

2. The system of claim 1, further comprising an advertisement delivery module for managing the delivery of said advertisements to the electronic devices.

3. The system of claim 2, further comprising a computer-readable storage medium operable to store said advertisements prior to delivery to said electronic devices.

4. The system of claim 1, further comprising a computer-readable storage medium, wherein said communications module and said rendering management module each comprises computer code stored on said computer-readable storage medium.

5. The system of claim 4, further comprising at least one computer processor for executing the computer code.

6. The system of claim 1, wherein said information is received by the communications module over a computer network.

7. The system of claim 1, further comprising an opportunity detection module operable to recognize advertisement placement opportunities in relation to at least one content stream.

8. The system of claim 1, wherein said rendering management module is further operable to cause an increase in the rendering of the advertisements on the electronic devices in response to an acceptable service level at the service center.

9. The system of claim 1, wherein said rendering management module is further operable to cause a decrease in the rendering of the advertisements on the electronic devices in response to an unacceptable service level at the service center.

10. The system of claim 1, wherein said advertisement conveys contact information for said service center.

11. The system of claim 1, wherein said service center is at least one of a telephone center and a live chat center.

12. The system of claim 1, further comprising a comparison module for comparing target profiles associated with said advertisements to consumer profiles.

13. The system of claim 1, further comprising a monitoring module for determining the service level of the service center.

14. An electronic device for presenting an advertisement, comprising:
a computer-readable storage medium for storing said advertisement;
a communications module for receiving a command signal operable to cause said advertisement to be rendered; and
a rendering module for rendering said advertisement in response to said command signal;
wherein said command signal is related to a service level at a service center such that said advertisement is rendered when said service level is at an acceptable level.

15. The electronic device of claim 14, further comprising an output module for displaying the advertisement.

16. The electronic device of claim 14, further comprising an opportunity detection module operable to determine an advertisement placement opportunity for the advertisement in relation to a content stream.

17. The electronic device of claim 16, wherein said opportunity detection module determines the advertisement placement opportunity for the advertisement in response to the receipt of the command signal.

18. The electronic device of claim 16, further comprising a switching module for switching between the content stream and the advertisement.

19. The electronic device of claim 14, further comprising a user identification module for identifying a user of the electronic device.

20. The electronic device of claim 19, wherein said user identification module is operable to passively identify the user of the electronic device.

21. The electronic device of claim 14, wherein said advertisement conveys contact information for said service center.

22. The electronic device of claim 14, further comprising at least one computer processor for executing computer code.

23. An electronic device for presenting an advertisement, comprising:
a means for electronically storing said advertisement;
a means for rendering said advertisement; and
a means for receiving a command signal operable to cause said advertisement to be rendered;
wherein said command signal is indicative of a service level at a service center such that said advertisement is rendered when said service level is at an acceptable level.

24. The device of claim 23, further comprising a means for displaying the advertisement.

25. The device of claim 23, further comprising a means for determining an advertisement placement opportunity for the advertisement in relation to a content stream.

26. The device of claim 25, further comprising a means for switching between said content stream and said advertisement.

27. The device of claim 23, further comprising a means for identifying a user of the electronic device.

28. The device of claim 23, further comprising a means for passively identifying a user of the electronic device.

29. The device of claim 23, wherein said advertisement conveys contact information for said service center.

30. The device of claim 23, further comprising a processing means for executing computer code.

31. A method of rendering an advertisement on a plurality of electronic devices, said method comprising:
receiving, at a network gateway module, service level information related to a service level at a service center;
determining, in a rendering management module, if an advertisement should be rendered on an electronic device in response to the service level information;
transmitting, via a communications module, a rendering command to the electronic device, the rendering command to regulate rendering of the advertisement on the electronic device.

32. The method of claim 31, further comprising disseminating, via an advertisement delivery module, the advertisement to each of the plurality of electronic devices.

33. The method of claim 31, further comprising storing the advertisement in a computer-readable storage medium.

34. The method of claim 31, further comprising determining an advertisement placement opportunity for the advertisement in relation to at least one content stream.

35. The method of claim 31, further comprising increasing the renderings of the advertisement when said service level at the service center is acceptable.

36. The method of claim 31, further comprising decreasing the renderings of the advertisement when said service level at the service center is unacceptable.

37. The method of claim 31, further comprising monitoring the service level and the service center.

38. A method of rendering an advertisement on an electronic device, said method comprising:
receiving the advertisement over a network;
storing the advertisement in a computer-readable storage medium; and
rendering the advertisement on an output module of the electronic device in response to a command signal indicative that a service level at a service center is at an acceptable level.

39. The method of claim 38, further comprising identifying a user of the electronic device.

40. The method of claim 38, further comprising reporting that the advertisement has been rendered.

41. The method of claim 38, further comprising determining an advertisement placement opportunity for the advertisement in relation to a content stream.

42. The method of claim 38, wherein said advertisement conveys contact information for said service center.

43. A method of rendering an advertisement to a consumer via an electronic device, said method comprising the steps of:
monitoring a service level of a service center;
determining, in a rendering management module, if said service level is acceptable; and
rendering the advertisement on an output module of said electronic device to the consumer in response to determining that said service level is acceptable.

44. The method of claim 43, further comprising determining an advertisement placement opportunity for the advertisement in relation to a content stream.

45. A system for presenting advertisements, comprising:
a centralized computer system comprising:
a communications module for receiving information regarding a service level at a service center,
a rendering management module for generating command signals based upon the information, said command signals regulating the rendering of the advertisements, and
said communications module further operable to transmit the command signals generated by said rendering management module; and
a remote electronic device comprising:
a computer-readable storage medium for storing said advertisements,
a communications module for receiving the command signals,
a rendering module for rendering said advertisements in response to said command signals,
an output module for displaying the advertisements, and
an opportunity detection module operable to determine advertisement placement opportunities for the advertisements in relation to a content stream.
